(19) United States
(12) Patent Application Publication
(10) Pub. No.: US 2008/0219421 A1
(43) Pub. Date: Sep. 11, 2008

(54) System and Method for Transferring Credit Between Subscribers of Differing Telecommunications Carriers

(75) Inventor: Eugenio Donato Renato Limlengco Enriquez, Makati City (PH)

Correspondence Address: INTELLECTUAL PROPERTY LAW GROUP LLP, 12 SOUTH FIRST STREET, SUITE 1205, SAN JOSE, CA, 95113, US

(73) Assignee: Paysetter Pte Ltd, Singapore (SG)

(21) Appl. No.: 11/571,248

(22) PCT Filed: Jun. 22, 2005
(86) PCT No.: PCT/SG05/00204

§ 371 Date: Dec. 10, 2007

(30) Foreign Application Priority Data
Jun. 22, 2004 (SG) 200403791-7
Jul. 13, 2004 (SG) 200404348-5

(51) Int. Cl. H04M 15/00

(52) U.S. Cl. 379/114.21

(57) ABSTRACT

A system for transferring credit between subscribers (12) of differing telecommunications carriers (14). The system involves a first subscriber (12a) sending a communication message (26), via a first communication device (16a), to a destination address (24) associated with a payment facilitator (22a) possessed by a first telecommunication carrier (14a). The communication message (26) includes the unique identifier of a second communication device (16b) possessed by a second subscriber (12b) of a second telecommunication carrier (14b) and the amount to be transferred. The payment facilitator (22a) of the first telecommunication carrier (14a) determines the identity of the first subscriber (12a) by ascertaining the unique identifier of the first communication device (16a). With this knowledge, the payment facilitator (22a) then operates to debit the credit balance the first subscriber (12a) has with the first communication device (16a) by a total transfer cost amount, which factors in the amount to be transferred in the communication message (26). At the same time the payment facilitator (22a) of the first telecommunications carrier (14a) interfaces with the payment facilitator (22b) of the second telecommunications carrier (14b) and instructs the payment facilitator (22b) of the second telecommunications carrier (14b) to credit the credit balance the second subscriber (12b) has with the second communication device (16b) by a total transferred amount, which also factors in the amount to be transferred in the communication message (26).

### FIELD OF THE INVENTION

The present invention relates to a system and method for transferring credit between subscribers of differing telecommunications carriers. The invention is particularly suited, but need not be exclusively used in the context of, transferring credit between a subscriber of a first telecommunications carrier and a subscriber of a second telecommunications carrier, where the first and second telecommunications carriers operate in different countries.

### BACKGROUND ART

The following discussion of the background of the invention is intended to facilitate an understanding of the invention. However, it should be appreciated that the discussion is not an acknowledgement or admission that any of the material referred to was published, known or part of the common general knowledge of the person skilled in the art in any jurisdiction as at the priority date of the application.

It has recently become possible for mobile phone subscribers of telecommunications carriers to transfer air-time credit to another subscriber of the same telecommunication carrier. An example of one such system is the applicant's Autoload™ system. However, due to many factors including currency issues, identification and authentication issues and the use of differing billing systems, it has not been possible for a subscriber of one telecommunications carrier to transfer air-time credit to a subscriber of a differing telecommunications carrier.

It is an object of the present invention to allow a subscriber of a first telecommunications carrier to transfer air-time credit to a subscriber of a second telecommunications carrier—regardless of the area of operation of the second telecommunications carrier in comparison to the first telecommunications carrier.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

In accordance with a first aspect of the present invention there is provided a system for transferring credit between subscribers of differing telecommunications carriers. The system involves a first subscriber sending a text based communication message, via a first communication device, to a destination address associated with a payment facilitator possessed by a first telecommunication carrier. The text based communication message includes the unique identifier of a second communication device possessed by a second subscriber of a second telecommunication carrier and the amount to be transferred. The payment facilitator of the first telecommunication carrier determines the identity of the first subscriber by ascertaining the unique identifier of the first communication device. With this knowledge, the payment facilitator then operates to debit the credit balance the first subscriber has with the first communication device by a total transfer cost amount, which factors in the amount to be transferred in the text based communication message. At the same time the payment facilitator of the first telecommunications carrier interfaces with the payment facilitator of the second telecommunications carrier and instructs the payment facilitator of the second telecommunications carrier to credit the credit balance the second subscriber has with the second communication device by a total transferred amount, which also factors in the amount to be transferred in the text based communication message.

The total transfer cost amount may equal the amount to be transferred as specified in the text based communication message (in which case the amount to be transferred, is specified in the local currency of the first telecommunication carrier). Alternatively, the total transfer cost amount may equal the amount to be transferred divided by the prevailing exchange rate, or a pre-agreed exchange rate, of the local currency of the second telecommunication carrier (in which case the amount to be transferred is specified in the local currency of the second telecommunication carrier). Commission and transaction fees may also be factored into the total transfer cost amount.

In a similar manner, the total transferred amount may differ from the amount to be transferred as specified in the text based communication message depending on whether this specified amount relates to the local currency of the first or second telecommunication carrier. Regardless, the amount credited to the second subscriber is in the local currency of the second telecommunication carrier.

The first and second subscribers may operate either a pre-paid or post-paid communication service, with transfer of credit being a transfer of air-time credit. Alternatively, each subscriber may have an air-time credit value and a monetary credit value, the transfer above being in respect of the monetary credit value.

Preferably the first subscriber has allocated an air-time credit value and a monetary credit value, and the amount to be transferred may be selected from the air time credit value and/or the monetary credit value.

Alternatively, the first subscriber has allocated an air-time credit value or a monetary credit value, and the amount to be transferred is selected from the allocated credit value.

In either arrangement, the second subscriber may also have allocated an air-time credit value and a monetary credit value, and the first subscriber may select from these credit values of the second subscriber for the crediting of the amount being transferred.

The destination address may be associated with an amount to be transferred. Alternatively, the first subscriber may specify the amount to be transferred as a suffix of DTMF tones to the destination address. In either situation, the text based communication message need not specify an amount to be transferred.

Alternatively, or cumulatively, the first subscriber may specify the unique identifier of the second communication device as a suffix of DTMF tones to the destination address. In such instance, the text based communication message also need not specify the unique identifier of the second communication device.

In yet another arrangement, the same destination address may be used for transferring credit between subscribers of the same telecommunications carrier and subscribers of differing telecommunications carriers. Determination of which transfer is intended can be achieved by parsing the unique identifier of the second communication device to determine an international prefix and telecommunication carrier provider code. If the combination of international prefix and telecommunication carrier differs from the international prefix and telecommunication carrier of the telecommunication carrier who receives the text based communication message, then the transfer is treated as a transfer between differing telecommunications carriers.

Transfer of credit may be subject to an authentication process. The authentication process may be waived on first transfer. Means of authentication may include PIN, password or biometric identifier.

Transfers may also be subject to a number of preliminary checks. Checks may be made to ensure that the unique identifier of the second communication device includes a recognisable combination of international prefix and telecommunication carrier provider code (in the sense that that carrier has joined the system). Further checks may also be made to ensure that the first subscriber has sufficient credit to cover the total transfer cost amount and that the unique identifier of the second communication device specified in the text based communication message is a valid unique identifier.

The payment facilitator of the first telecommunication carrier may operate to generate a trace number for the transfer. The second telecommunication carrier may operate to record this trace number for reconciliation purposes. Alternately, the second telecommunication carrier may operate to generate their own trace number. In the latter arrangement, some link must be established between the two trace numbers to facilitate reconciliation.

Ascertaining the unique identifier of the first communication device may be achieved by way of caller identification or other similar techniques. In this manner, confirmation and other communication messages may be sent to the first and second subscribers regarding the transfer.

Error-checking and similar facilities may be employed. In the case of an error occurring part way through the transfer, roll-back arrangements may also be employed.

The first and second telecommunication carriers may undertake reconciliation and settlement activities between themselves.

The payment facilitators may be operated by their respective telecommunication carriers. Alternatively, they may be operated by a third party. In this latter arrangement, the third party undertakes reconciliation and settlement activities in conjunction with each telecommunication carrier.

Ideally, the communication device is a mobile phone. However, any mobile device capable of two-way communication via a communications network operated by a telecommunication carrier may be used in its place. Similarly, while the preferred means of text based communication message is by way of Short Message Service messages, MMS or e-mail messages may also be used.

The first and second telecommunications carriers may be geographically separate, such as in different countries, or operate in the same geographic area, such as the same capital city.

In accordance with a second aspect of the present invention there is a method of transferring credit between subscribers of differing telecommunications carriers substantially as described above.

In accordance with yet further aspects of the present invention there are telecommunication carriers for use in a system for transferring credit between subscribers of differing telecommunication carriers substantially as described above and payment facilitators for use in a system for transferring credit between subscribers of differing telecommunication carriers substantially as described above.

### BRIEF DESCRIPTION OF THE DRAWINGS

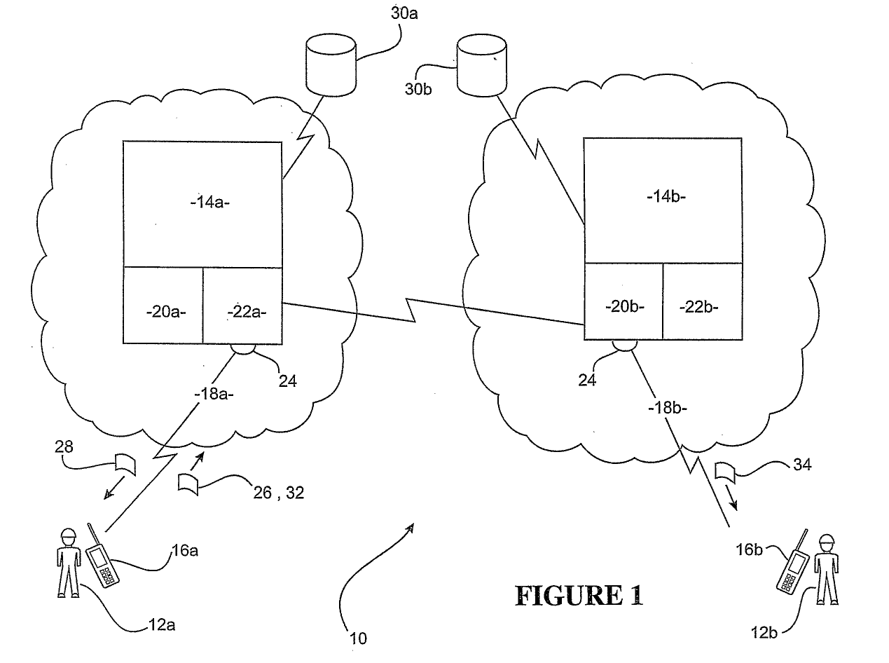

A preferred embodiment of the invention will now be described in the context of the following drawing, FIG. 1, which is a schematic view of a system for transferring credit between subscribers of differing telecommunications carriers.

### BEST MODE(S) FOR CARRYING OUT THE INVENTION

FIG. 1 illustrates a first embodiment of a system 10 for transferring credit between subscribers 12 of differing telecommunications carriers 14. Each subscriber 12 has a mobile phone 16 which uses the mobile phone network 18 of the telecommunications carrier 14 to whom he/she subscribes to communicate. Each telecommunications carrier 14 has a billing system 20 and a payment facilitator 22. The payment facilitator 22 is in data and control communication with the billing system 20. Each payment facilitator 22 is also in data and control communication with each other payment facilitator 22.

The billing system 20 is best considered as a database. At least one record in billing system 20a represents subscriber's 12a account with telecommunications carrier 14a. At least one record in billing system 20b represents subscriber's 12b account with telecommunications carrier 14b.

The invention will now be described in the context of the following example. Additional features necessary to the operation of the system 10 may also be introduced in the context of the following example.

Subscriber 12a is in possession of mobile phone 16a operating under a post-paid payment plan. Mobile phone 16a uses mobile phone network 18a to communicate. Mobile phone network 18a is operated by telecommunications carrier 14a.

Subscriber 12b is also in possession of a mobile phone 16b. Mobile phone 16b operates under a pre-paid payment plan. Mobile phone 16b uses mobile phone network 18b to communicate. Mobile phone network 18b is operated by telecommunications carrier 14b.

Telecommunications carrier 14a operates in a different country to telecommunications carrier 14b.

As mentioned above, each telecommunications carrier 14 has their own payment facilitator 22 and billing system 20. Each payment facilitator 22 has its own destination address 24 to which a text based communication message, such as a short messaging system message, can be sent.

Each billing system 20 comprises a series of customer account records. Each customer account record includes at least the following information in respect of a subscriber 12 to whom the customer account record corresponds:
the mobile phone number of the subscriber 12 (acting as the primary key for the customer account record);
a PIN for authenticating the identity of the subscriber 12; and
an account balance of air-time credit.

For the purposes of this example, a customer account record in billing system 20a corresponds with subscriber 12a. A customer account record in billing system 20b corresponds with subscriber 12b. Further, it is presumed that both customer account records have been populated with air-time credit and a PIN through techniques beyond the scope of this invention but within the realm of the person skilled in the art.

In order to transfer air-time credit, subscriber 12a sends an SMS message 26, using mobile phone 16a, to destination address 24a. SMS message 26 includes the following information:
The amount to be transferred in the local currency of the intended recipient, ie. subscriber 12b;
The mobile phone number of mobile phone 16b possessed by subscriber 12b; and
The PIN as recorded in subscriber's 12a corresponding customer account record.

On receipt of the SMS message 26 at destination address 24a, payment facilitator 22a operates to parse the SMS message 26 to determine each piece of information mentioned above. At the same time, the payment facilitator 22a operates to obtain the mobile phone number of mobile phone 16a using techniques as would be known to the person skilled in the art, such as caller identification.

The payment facilitator 22a then further parses the mobile phone number of mobile phone 16b to determine:
the international prefix; and
the telecommunications carrier provider code.

The payment facilitator 22a then operates to check the combination of international prefix and telecommunications carrier provider code against a set of records of partnered telecommunication carriers 14. If a match cannot be found, the payment facilitator 22a operates to send a denial SMS message 28 to mobile phone 16a.

In this example, the combination of international prefix and telecommunications carrier provider code points to telecommunications carrier 14b. The payment facilitator 22a thereafter checks the corresponding record for telecommunications carrier 14b in the set of records of partnered telecommunications carriers 14 to determine the local currency of telecommunications carrier 14b.

At the same time the payments facilitator 22a operates to determine the subscriber's 12a corresponding customer account record, by seeking a match between the ascertained mobile phone number of mobile phone 16a and the mobile phone numbers recorded as part of each customer account record. On identifying a matching record, the payments facilitator 22a:
1. Divides the amount to be transferred by the prevailing exchange rate for the local currency of telecommunications carrier 14b, thus determining the transaction cost; and
2. Checks whether the account balance of the matching record has sufficient credit to cover the transaction cost.

If as a result of the account balance check, the payments facilitator 22a determines that the account balance has insufficient credit to cover the transaction cost, then an alternate denial SMS message 28 is sent to mobile phone 16a.

If, however, there is sufficient credit to cover the transaction cost, the payments facilitator 22a interfaces with payments facilitator 22b of telecommunications carrier 14b to check that the mobile phone number included in SMS message 26 is valid. This check is within the knowledge of the person skilled in the art and therefore will not be described in further detail here.

If this check determines that the mobile phone number included in SMS message 26 is invalid, then, again, an alternate denial SMS message 28 is sent to mobile phone 16a.

If this check determines that that the mobile phone number included in SMS message 26b is valid, then payments facilitator 22a:
debits the account balance of the matching record by the calculated transaction cost amount;
issues a command to payments facilitator 22b, via its established interface, to credit the account balance of the record matching the mobile phone number included in SMS message 26 by the amount specified in SMS message 26;
generates a trace number for the transaction and records the details of the transaction, including the trace number, in a transaction database 30a;
sends a confirmation SMS message 32 to mobile phone 16a informing subscriber 12a that the transfer has been successful and providing them with the trace number for the transaction.
issues a command to telecommunications carrier 14b, via its interface with payment facilitator 22b, to send a receipt SMS message 34 to mobile phone 16b informing subscriber 12b that a transfer has taken place, the amount they have received, and the trace number for the transaction.

Payments facilitator 22b then operates, in accordance with the received command from payments facilitator 22a, to credit the account balance of the record matching the mobile phone number included in SMS message 26 by the amount specified in SMS message 26.

If for any reason one or more of the above steps fail, a rollback procedure is initiated to undo those steps already completed and a denial SMS message 26 is sent to mobile phone 16a.

At the end of each day, each payment facilitator 22 performs a reconciliation on all transactions that it has processed. The reconciliation is grouped according to telecommunication carriers 14 with whom the payment facilitator 22 has interfaced as part of a transaction. Thus, reconciliation information specific to a telecommunication carrier 14 can be sent to that telecommunication carrier 14 for verification against their internal reconciliation information. If there is any discrepancy, an investigation can be undertaken to determine the reason for the discrepancy. In this manner, fraud on the system is hopefully minimised.

In addition to reconciliation, at predetermined periods, settlement between telecommunication carriers 14 will occur. Settlement sees each payment facilitator 22 offset the sum of transaction amounts it has received (in its local currency) from another telecommunication carrier 14 against the sum of transaction cost amounts it has to pay out to that other telecommunication carrier 14. If, even after factoring in the offset amount, the sum of transaction amounts it has received remains positive, then the telecommunications carrier 14 concerned operates to make payment to the other telecommunication carrier 14 equal to this amount.

To elaborate, in the above example, during settlement telecommunication carrier 14a will be required to make an electronic payment to telecommunication carrier 14b equal to the amount specified in SMS message 26.

In each case mentioned above, denial communication message 28 informs subscriber 12a of the reason for the denial. In this manner, the subscriber 12a can take appropriate steps to correct the situation before retrying the transfer.

It should be appreciated by the person skilled in the art that the invention is not limited to the examples described. In particular, the following additions and/or modifications can be made without departing from the scope of the invention:
Subscribers 12 may have either a pre-paid or post-paid mobile phone account. In respect of subscriber 12a, when operating a post-paid account, the calculated transaction cost amount as added to the amount owed for the billing period. In respect of subscriber 12b, when operating a post-paid account, the amount specified in SMS message 26 is applied to the subscriber's 12b account as if a bill payment equal to that amount had been made.
Telecommunication carriers 14a and 14b need not be geographically separate. It is possible for the telecommunication carriers 14 to operate in the same geographical region, such as a capital city.
Payment facilitators 22 may be owned and operated by the telecommunication carriers 14. Alternatively, payment facilitators 22 may be owned and/or operated by a third party. In this latter arrangement, settlement may be between the third party and the respective telecommunication carriers 14 rather than between telecommunication carriers 14 themselves.
Other forms of authentication may be used in place of the PIN. For example, the replacement may take the form of a biometric identifier or a password.
While text based communication messages have been described in the context of SMS messages, it is possible to use other formats such as MMS or e-mail to facilitate the transfer.
The system 10 may be adapted to include a credit balance for each subscriber 12a, 12b separate of the subscriber's 12 air-time credit balance. In this manner, transfer of monetary credit, rather than air-time credit, can be facilitated using the system 10.
Techniques for identifying the mobile phone number of subscriber 16a from the communication message, other than called identification, may be used in the system.
The system 10 may be arranged so that the first transaction undertaken by a subscriber 12 does not require any authentication requirements. However, in such an arrangement it is expected that the subscriber 12 will be required to complete a procedure by which information can be stored in their corresponding customer account record to facilitate authentication during subsequent transactions.
Commission and transaction fees may also be taken into account when calculating the transaction cost.
The same destination address 24 may be used for credit transfers between subscribers 12 of the same telecommunications carrier 14 as well as for credit transfers between subscribers 12 of different telecommunications carriers 14. In this manner, the type of credit transfer to take place may be ascertained by way of parsing the mobile phone number of the intended recipient (ie. subscriber 12b in the above example) to determine the international code and telecommunications carrier provider code. If the combination of international code and telecommunications carrier provider code differs from that of the telecommunications carrier 14 who received the credit transfer text based communication message, then the system 10 described above is implemented—the indication being that the credit transfer is to be between subscribers 12 of differing telecommunications carriers 14.
Reconciliation may be performed on a more or less frequent basis than described above. Similarly, settlement may be performed on a periodic basis. The applicant's contemplate performing settlement on a fortnightly or monthly basis, but other periods may be implemented in the system 10.
The receipt SMS and confirmation SMS may include content in addition to that described above. For example, the receipt SMS may include a message from subscriber 16a as well as identification details for subscriber 16a. The confirmation message 16b may include details of the transaction for their own reconciliation purposes.
The mobile phone number of subscriber 12b may be included as a suffix of DTMF tones to the destination address. Alternatively, a series of destination addresses may be used with each destination address having a predetermined amount attributed to it. In such situations, the mobile phone number of the subscriber 12b, or the amount to be transferred, as appropriate, may be omitted from SMS message 26.
The payment facilitator 22 may operate to omit certain checks. For instance, the payment facilitator 22a may operate to debit the account balance of the matching record by the calculated transaction cost amount without performing a check as to whether subscriber 12a has an account balance sufficient to cover this charge;
A trace number allocated to a transaction by payment facilitator 22a may also be recorded by payment facilitator 22b to assist during reconciliation. Alternatively, payment facilitator 22b may generate its own trace number in respect of a transaction, in which case there needs to be some mechanism to map both trace numbers generated by the payment facilitators 22 to the one transaction.
For security reasons, the PIN or other authentication information may be stored separately from the customer's account record.
The amount specified in text based communication message 26 may be an amount in the local currency of telecommunications carrier 14a rather than the local currency of telecommunications carrier 14b. The conversion process mentioned above is then modified accordingly to reflect this situation. Irrespective, the amount credited to subscriber 12b is always in the local currency of telecommunications carrier 14b.
Rather than converting the amount specified in text based communication message 26 in accordance with the prevailing exchange rate, conversion may be made in accordance with pre-agreed exchange rates.

It should be further appreciated by the person skilled in the art that features and modifications discussed above, not being alternatives or substitutes, can be combined to form yet other embodiments that fall within the scope of the invention described.

1. A system for transferring credit between a first subscriber of a first telecommunications carrier and a second subscriber of a second telecommunications carrier,
each said telecommunications carrier having a billing system and being associated with a payment facilitator;
where said first subscriber sends a text based communication message, via a first communication device, to a destination address associated with said first telecommunication carrier, said text based communication message including a second communication device unique identifier of a second communication device possessed by said second subscriber, and including instructions to transfer an amount;
where the payment facilitator of said first telecommunication carrier ascertains a first communication device unique identifier of said first communication device to determine the identity of said first subscriber, and the payment facilitator of said first telecommunications carrier operates to debit the credit balance of the first subscriber in the billing system of said first telecommunications carrier of said amount and any service charge; and
the payment facilitator of said first telecommunications carrier interfaces with the payment facilitator of said second telecommunications carrier and instructs the payment facilitator of said second telecommunications carrier of said second communication device unique identifier and said amount, and the billing system of said second telecommunications carrier operates to credit the credit balance said second subscriber has with said second communication carrier by a total transferred amount.

2. A system as claimed in claim 1 wherein said text based communication message includes with the instructions to transfer said amount, instructions as to the amount to be transferred.

3. A system as claimed in claim 1 or 2 wherein the total transferred amount is based on said amount, less any commission deducted by said second telecommunications carrier.

4. A system as claimed in claim 1 or 2 wherein said communications carriers are based in jurisdictions having different legal tender, and the total transferred amount is based on said amount corrected for exchange rate differences, and less any commission deducted by said second telecommunications carrier.

5. A system as claimed in any one of the preceding claims wherein transfer of said amount is subject to an authentication process performed by said first telecommunications carrier.

6. A system as claimed in claim 5 wherein said text based communication message includes a PIN, a password, or data from a biometric identifier for use in said authentication process.

7. A system as claimed in any one of the preceding claims wherein said first subscriber has allocated an air-time credit value and a monetary credit value, and said amount may be selected from said air time credit value and/or said monetary credit value.

8. A system as claimed in any one of claims 1 to 6 wherein said first subscriber has allocated an air-time credit value or a monetary credit value, and said amount is selected from the allocated credit value.

9. A system as claimed in claim 7 or 8 wherein said second subscriber has allocated an air-time credit value and a monetary credit value, and said first subscriber may select from said air-time credit value and said monetary credit value of said second subscriber for the crediting of said credit being transferred.

10. A system as claimed in any one of the preceding claims wherein the transfer of said amount is entered by said first subscriber into said text based communication message as a suffix of DTMF tones.

11. A system as claimed in any one of the preceding claims wherein said first subscriber specifies the second communication device unique identifier of the second communication device as a suffix of DTMF tones to the destination address.

12. A system as claimed in any one of the preceding claims wherein said first telecommunications carrier performs a preliminary check to ensure that the unique identifier of the second communication device includes a recognisable combination of international prefix and telecommunication carrier provider code to determine whether the second telecommunications carrier is compatible with the system.

13. A system as claimed in any one of the preceding claims wherein said first telecommunications carrier performs a preliminary check to ensure that the unique identifier of the second communication device specified in the text based communication message is a valid unique identifier.

14. A system as claimed in any one of the preceding claims wherein said first telecommunications carrier performs a preliminary check to ensure that the first subscriber has sufficient credit to cover said amount.

15. A system as claimed in any one of the preceding claims wherein the payment facilitator of the first telecommunication carrier generates a trace number for the transfer, and said second telecommunications carrier operates to record this trace number in the billing system of said second telecommunications carrier for reconciliation purposes.

16. A system as claimed in any one of claims 1 to 14 wherein the payment facilitator of the first telecommunication carrier generates a trace number for the transfer, and said second telecommunication carrier generates a second trace number, and a referencing link is established between the two trace numbers to facilitate reconciliation.

17. A system as claimed in any one of the preceding claims wherein confirmation and other communication messages are sent to the first and second subscribers regarding the transfer.

18. A system as claimed in any one of the preceding claims wherein error-checking is employed, and in the case of an error occurring in the transfer, roll-back arrangements are implemented.

19. A system as claimed in any one of the preceding claims wherein the payment facilitators are operated by entities selected from the respective telecommunication carriers or the same or different third parties.

20. A system as claimed in claim 19 wherein a said payment facilitator is operated by a third party, and the third party undertakes reconciliation and settlement activities in conjunction with each telecommunication carrier.

21. A method of transferring credit between a first subscriber of a first telecommunications carrier and a second subscriber of a second telecommunications carrier, each said telecommunications carrier having a billing system and being associated with a payment facilitator;
where a destination address associated with said first telecommunication carrier receives a text based communication message from said first subscriber sent via a first communication device, said text based communication message including a second communication device unique identifier of a second communication device possessed by said second subscriber, and including instructions to transfer an amount;
where the payment facilitator of said first telecommunication carrier ascertains a first communication device unique identifier of said first communication device to determine the identity of said first subscriber, and the payment facilitator of said first telecommunications carrier operates to debit the credit balance of the first subscriber in the billing system of said first telecommunications carrier of said amount and any service charge; and
the payment facilitator of said first telecommunications carrier interfaces with the payment facilitator of said second telecommunications carrier and instructs the payment facilitator of said second telecommunications carrier of said second communication device unique identifier and said amount, and the billing system of said second telecommunications carrier operates to credit the credit balance said second subscriber has with said second communication carrier by a total transferred amount.

22. A method as claimed in claim 21 wherein said text based communication message includes with the instructions to transfer said amount, instructions as to the amount to be transferred.

23. A method as claimed in claim 21 or 22 wherein the total transferred amount is determined based on said amount, less any commission deducted by said second telecommunications carrier.

24. A method as claimed in claim 21 or 22 wherein said communications carriers are based in jurisdictions having different legal tender, and the total transferred amount is determined based on said amount corrected for exchange rate differences, and less any commission deducted by said second telecommunications carrier.

25. A method as claimed in any one of claims 21 to 24 wherein said first telecommunications carrier performs an authentication process prior to effecting transfer of said amount.

26. A method as claimed in claim 25 wherein said authentication process is performed using, a PIN, a password, or data from a biometric identifier included in said text based communication message.

27. A method as claimed in any one of claims 21 to 26 wherein said first telecommunications carrier performs a preliminary check to ensure that the unique identifier of the second communication device includes a recognisable combination of international prefix and telecommunication carrier provider code to determine whether the second telecommunications carrier is compatible with the system.

28. A method as claimed in any one of claims 21 to 27 wherein said first telecommunications carrier performs a preliminary check to ensure that the unique identifier of the second communication device specified in the text based communication message is a valid unique identifier.

29. A method as claimed in any one of claims 21 to 28 wherein said first telecommunications carrier performs a preliminary check to ensure that the first subscriber has sufficient credit to cover said amount.

30. A method as claimed in any one of claims 21 to 29 wherein the payment facilitator of the first telecommunication carrier generates a trace number for the transfer, and said second telecommunications carrier operates to record this trace number in the billing system of said second telecommunications carrier for reconciliation purposes.

31. A method as claimed in any one of claims 21 to 29 wherein the payment facilitator of the first telecommunication carrier generates a trace number for the transfer, and said second telecommunication carrier generates a second trace number, and a referencing link is established between the two trace numbers to facilitate reconciliation.

32. A method as claimed in any one of claims 21 to 31 wherein confirmation and other communication messages may be sent to the first and second subscribers regarding the transfer.

33. A method as claimed in any one of claims 21 to 32 wherein error-checking is employed, and in the case of an error occurring in the transfer, roll-back arrangements are implemented.

34. A method as claimed in any one of claims 21 to 33 wherein the payment facilitators are operated by entities selected from the respective telecommunication carriers or the same or different third parties.

35. A method as claimed in claim 34 wherein a said payment facilitator is operated by a third party, and the third party undertakes reconciliation and settlement activities in conjunction with each telecommunication carrier.

36. A telecommunications carrier server for use in a system for transferring credit between a first subscriber of said telecommunications carrier and a second subscriber of a second compatible telecommunications carrier,
said telecommunications carrier having or being interfaced with a billing module, and being associated with a payment facilitator;
where said first subscriber sends a text based communication message, via a first communication device, to a destination address of said telecommunications carrier server, said text based communication message including a second communication device unique identifier of a second communication device possessed by said second subscriber, and including instructions to transfer an amount;
where the payment facilitator associated with said telecommunications carrier server ascertains a first communication device unique identifier of said first communication device to determine the identity of said first subscriber, and the payment facilitator associated with said telecommunications carrier server operates to debit the credit balance of the first subscriber, in the billing module of said first telecommunications carrier server of said amount and any service charge;
and the payment facilitator of said first telecommunications carrier interfaces with said second compatible telecommunications carrier and sends an instructing message instructing said second compatible telecommunications carrier of said second communication device unique identifier and said amount, and said second compatible telecommunications carrier operates to credit the credit balance said second subscriber has with said second compatible communication carrier by a total transferred amount;
where on receipt of a further instructing message from a compatible telecommunications carrier concerning transfer of a said amount to a subscriber, said telecommunications carrier server determines the unique identifier of said subscriber and said amount from said further instructing message, and the billing module of said telecommunications carrier server operates to credit the credit balance said subscriber has with said communication carrier by a total transferred amount.

37. A server as claimed in claim 36 wherein said text based communication message includes with the instructions to transfer said amount, instructions as to the amount to be transferred.

38. A server as claimed in claim 36 or 37 wherein the total transferred amount is based on said amount, less any commission deducted by said compatible telecommunications carrier.

39. A server as claimed in claim 36 or 37 wherein said communications carriers are based in jurisdictions having different legal tender, and the total transferred amount is based on said amount corrected for exchange rate differences, and less any commission deducted by said compatible telecommunications carrier.

40. A server as claimed in any one of claims 36 to 39 wherein transfer of said amount is subject to an authentication process performed by said telecommunications carrier server.

41. A server as claimed in claim 40 wherein said text based communication message includes a PIN, a password, or data from a biometric identifier for use in said authentication process.

42. A server as claimed in any one of claims 36 to 41 wherein the transfer of said amount is entered by said first subscriber into said text based communication message as a suffix of DTMF tones.

43. A server as claimed in any one of claims 36 to 42 wherein said first subscriber specifies the second communication device unique identifier of the second communication device as a suffix of DTMF tones to the destination address.

44. A server as claimed in any one of claims 36 to 43 wherein said telecommunications carrier server performs a preliminary check to ensure that the unique identifier of the second communication device includes a recognisable combination of international prefix and telecommunication carrier provider code to determine whether the second telecommunications carrier is compatible.

45. A server as claimed in any one of claims 36 to 44 wherein said telecommunications carrier server performs a preliminary check to ensure that the unique identifier of the second communication device specified in the text based communication message is a valid unique identifier.

46. A server as claimed in any one of claims 36 to 45 wherein said telecommunications carrier server performs a preliminary check to ensure that the first subscriber has sufficient credit to cover said amount.

47. A server as claimed in any one of claims 36 to 46 wherein the payment facilitator associated with the telecommunications carrier server generates a trace number for the transfer, and said second compatible telecommunications carrier operates to record this trace number for reconciliation purposes.

48. A server as claimed in any one of claims 36 to 46 wherein the payment facilitator associated with the telecommunications carrier server generates a trace number for any transfer, and establishes a referencing link between said trace numbers and a further trace number generated in a compatible telecommunications carrier to facilitate reconciliation.

49. A server as claimed in any one of claims 36 to 48 wherein confirmation and other communication messages are sent to subscribers regarding the transfer.

50. A server as claimed in any one of claims 36 to 49 wherein error-checking is employed, and in the case of an error occurring in the transfer, roll-back arrangements are implemented.

51. A server as claimed in any one of claims 36 to 50 wherein the payment facilitators comprise modules located on said server.

52. A server as claimed in any one of claims 36 to 50 wherein the payment facilitators comprise modules located on a different server.

53. Computer media containing instructions for programming a telecommunications carrier server according to any one of claims 36 to 52.

54. A telecommunications carrier server substantially as herein described with reference to the drawing.

55. A system for transferring credit substantially as herein described with reference to the drawing.

56. A method of transferring credit substantially as herein described with reference to the drawing.
